(19) United States
(12) Patent Application Publication
(10) Pub. No.: US 2021/0034029 A1
(43) Pub. Date: Feb. 4, 2021

(54) BINDERS FOR MILLING TOOLS USING WURTZITE BORON NITRIDE (W-BN) SUPERHARD MATERIAL

(71) Applicant: Saudi Arabian Oil Company, Dhahran (SA)

(72) Inventors: Guodong Zhan, Dhahran (SA); Mohammed Badran, Dhahran (SA); Timothy E. Moellendick, Dhahran (SA)

(73) Assignee: Saudi Arabian Oil Company, Dhahran (SA)

(21) Appl. No.: 16/524,982

(22) Filed: Jul. 29, 2019

(51) Int. Cl. G05B 19/042; B01J 3/06; B01J 3/03; B22F 7/00; B22F 7/06; G06F 9/04; G06F 9/30

(52) U.S. Cl. CPC G05B 19/0421; B01J 3/065; B01J 3/03; B22F 7/008; B22F 7/06; G06F 9/04; B22F 2999/00; B01J 2203/066; B22F 2301/15; B22F 2301/35; B22F 2302/205; B22F 2303/20; B22F 2998/10; G06F 9/30

(57) ABSTRACT

Systems and methods include a computer-implemented method for manufacturing a binder for spraying onto tools. A binder is manufactured for binding compacts onto a tool substrate. The binder is designed to provide a coating strength on the tool substrate. The binder includes: a metal selected from iron (Fe), cobalt (Co), and nickel (Ni); an alloy including the metal selected from Fe, Co, and Ni; or a refractory alloy selected from tungsten, tantalum (Ta), molybdenum (Mo), and niobium (Nb). An ultra-high-pressure, high-temperature operation is performed on pure wurtzite boron nitride (w-BN) powder to synthesize w-BN and cubic boron nitride (c-BN) compact. A binder-compact mixture is produced by turbulently mixing the binder with the compact in a mixer within a vacuum. The binder-compact mixture is thermally sprayed onto a tool substrate to coat the tool.

### BACKGROUND

The present disclosure applies to synthesizing superhard materials for coating milling tools. Milling can be used in workover operations, such as in oil wells. Milling operations can be time-consuming and costly. Mill tool materials typically include tungsten carbide (WC) materials, with a hardness of approximately 20 gigapascals (GPa). Milling tools can have different morphologies for different applications, such as packer milling-retrieving tools, flat bottom mills, concave mills, washover shoes, string mills, tape mills, bladed mills, and economills. Conventional milling tools may not provide enough wear resistance and thermal stability for fast milling. Diamond would be an ideal material, but diamond is not suitable for milling ferrous drilling tools.

In some implementations, milling tool sizes usually range from 3½″ to 28″. After each use, the mill is typically redressed with a fresh layer of crushed tungsten. The mill body has many different designs that are determined by the necessary drilling application. Each type of mill performs better in certain applications, and best practices can be established for some milling operations. Packer milling and retrieving operations are common operations in the de-completion process.

### SUMMARY

The present disclosure describes techniques that can be used for synthesizing (and coating tools with) a single-phase, pure, polycrystalline wurtzite boron nitride (w-BN) material. In some implementations, the techniques can include the following aspects. High purity (for example, over 99% pure) w-BN and cubic boron nitride (c-BN) compact is synthesized from w-BN powder under ultra-high pressure (for example, a pressure of approximately 20 gigapascals) and high temperature (for example, in the range of 1100-1300° C.). Then, w-BN grits (for example, greater than 20 microns) are formed that are greater in size than particles of the w-BN powder. A binder is added to the grits, and the resulting mix is thermal sprayed onto a milling tool. This process can result in the production of high-performance milling tools that are built with new single-phase pure polycrystalline w-BN material, the hardest and the highest thermal stability milling material suitable for highly efficient workover operations.

The present disclosure relates to the construction techniques for milling tools constructed using a single phase polycrystalline w-BN material, providing a hard and high thermal stability milling material ideal for workover operations. The techniques can support oil wells, for example. The techniques can produce water well milling tools for diversification of underground work, well maintenance problems, and the application of milling tools which are increasingly being used to treat falling matter in oil wells. Tools created using the techniques can resolve issues such as tool string downhole cement solid die, packer stuck in the well, trimming faulting downhole casing deformation, cement solid dead string downhole, trimming downhole casing breaking deformation or dislocation, and drilling or workover treatment processes that cannot salvage falling objects in highly deviated wells and horizontal wells. For example, if a traditional centrifugal mill is used in deep well-grinding and milling operations, the working time is long, the operation cost is high, and the running cost is high. If the mill uses the traditional milling tool centrifugal shock in the deep set milling operations, a long running time and high risk can occur.

The techniques include aspects that are different from conventional technologies regarding w-BN. For example, in conventional technologies, w-BN is not pure, and neither are the starting powders from which w-BN is made. The techniques of the present disclosure can allow the successful synthesis of pure polycrystalline w-BN. The techniques can be used in the production of milling tools, using ultra-high-pressure synthesis of pure polycrystalline w-BN (or c-BN, or a mixture of w-BN and c-BN) from the w-BN starting powder. Thermal spraying can be used on tools used in demanding downhole tool milling applications. The techniques also include the preparation of a w-BN abrasive (for example, having a grit size greater than a threshold, such as 100 microns) from a block w-BN compaction by using a laser (or plasma or electron beam) to melt and cool. Smaller w-BN grits (for example, having a grit size less than a threshold, such as 100 microns) which are formed can be used for spraying coatings on the surface of the milling tools or on a number of bulk w-BN parts applied directly onto the milling tool. In order to form a firm bonding between the w-BN and the milling tool matrix, binders can be added before and after an ultra-high-pressure, high-temperature (UHPHT) process (for example, a pressure of approximately 20 gigapascals and a temperature in the range of 1100-1300° C.).

The techniques use w-BN starting powder to synthesize polycrystalline w-BN to manufacture milling tools. The w-BN used by conventional technologies is not pure. For example, hexagonal boron nitride (hBN) begins the material usage and leads to the mixing phase. Conventional w-BN applications are typically limited to cutting tool industries such as automotive and construction industries, for example, rather than the oil and gas industry. Moreover, conventional w-BN processes start from an hBN starting powder and not a pure phase. The tools that result from such conventional processes are not suitable for the oil and gas drilling and milling industries.

In some implementations, a computer-implemented method for manufacturing a binder for spraying onto tools includes the following. A binder is manufactured for binding compacts onto a tool substrate. The binder is designed to provide a coating strength on the tool substrate. The binder includes: a metal selected from iron (Fe), cobalt (Co), and nickel (Ni); an alloy including the metal selected from Fe, Co, and Ni; or a refractory alloy selected from tungsten, tantalum (Ta), molybdenum (Mo), and niobium (Nb). An ultra-high-pressure (for example, a pressure of approximately 20 gigapascals), high-temperature operation is performed on pure wurtzite boron nitride (w-BN) powder to synthesize w-BN and cubic boron nitride (c-BN) compact. A binder-compact mixture is produced by turbulently mixing the binder with the compact in a mixer within a vacuum. The binder-compact mixture is thermally sprayed onto a tool substrate to coat the tool.

In the present disclosure, a superhard pure w-BN single phase material is synthesized using an ultra-high-pressure, high-temperature (UHPHT) technology suitable for workover milling applications. The pure w-BN material possesses a superior hardness of ˜60 GPa, which is three times harder than current milling tools and provides excellent thermal stability that is required for milling. The new high-performance w-BN material is ideal for milling ferrous and non-ferrous drilling tool materials suitable for current workover operations.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method/the instructions stored on the non-transitory, computer-readable medium.

The subject matter described in this specification can be implemented in particular implementations so as to realize one or more of the following advantages. First, mill tool designs incorporating ultra-strong w-BN materials can provide exceptional durability. Second, more reliable mill tools can be created with catalyst-free ultra-strong w-BN materials made by ultra-high-pressure and high-temperature technology. Third, mill tools can be created with new and first time synthesized pure single phase w-BN materials. Fourth, mill tools failures can be reduced through the development of more reliable design methods with the potential to improve milling speed performances are needed. Fifth, while UHPHT-only disks or bulks are not suitable for oil and gasoline drilling applications, UHPHT w-BN can be joined to disks or bulks as a mill tools substrate to act as a superstrong cutting or milling layer. Sixth, mechanical and metallurgical methods or techniques, including tool designs and new thermal spraying techniques, can be used to make new w-BN milling tools. Seventh, w-BN milling cutters can possess a hardness more than three times as hard as commercially available WC milling cutters, providing a wear resistance directly proportional to hardness. Eighth, w-BN milling cutters can provide superior wear resistance. Ninth, w-BN milling materials can have a high fracture toughness which more readily withstand high impact loading during milling or drilling. Tenth, active metal brazing can facilitate the joining of tungsten carbide/cobalt (WC/Co) and polycrystalline diamond compacts (PDC) materials and components, which is especially beneficial in oil industry applications. Eleventh, the present disclosure provides a new kind of milling tool for oil wells and water wells, which is convenient in design, high in efficiency, and low in cost, improving oil milling maintenance work efficiency.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIGS. 1A-1D are diagrams showing examples of different types of packer picker tools (or packer milling-retrieving tools), according to some implementations of the present disclosure.

FIGS. 2A-2C are diagrams showing examples of different types of flat bottom mills, according to some implementations of the present disclosure.

FIGS. 3A-3E are diagrams showing examples of different types of concave mills, according to some implementations of the present disclosure.

FIGS. 4A-4C are diagrams showing examples of different types of washover shoes, according to some implementations of the present disclosure.

FIGS. 5A-5B are diagrams showing examples of different types of string mills or watermelon mills, according to some implementations of the present disclosure.

FIG. 6 is a diagram showing an example of a taper mill, according to some implementations of the present disclosure.

FIG. 7 is a diagram showing an example of a bladed mill, according to some implementations of the present disclosure.

FIGS. 8A-8E are diagrams showing examples of different types of internal cutter/section milling tools, according to some implementations of the present disclosure.

FIGS. 9A-9B are diagrams showing examples of different views of whipstock tools, according to some implementations of the present disclosure.

FIG. 10 is a diagram showing an example of an economill, according to some implementations of the present disclosure.

FIGS. 11A-11C are diagrams showing examples of different mill shapes, according to some implementations of the present disclosure.

FIG. 12 is a diagram showing examples of different types of tungsten carbide inserts, according to some implementations of the present disclosure.

FIG. 13 is a diagram showing an example of a tape mill tool designed and made from superstrong wurtzitic boron nitride (w-BN) material, according to some implementations of the present disclosure.

FIGS. 14A-14B are diagrams showing examples of a new string mill tool made from thermal sprayed w-BN superhard material, according to some implementations of the present disclosure.

FIG. 15 is a diagram showing an example of a ring mill tool made that includes attached or bonded w-BN superhard grit material, according to some implementations of the present disclosure.

FIG. 16 is a diagram showing an example of a plasma-spraying coating technology process, according to some implementations of the present disclosure.

FIG. 17 is a flow diagram showing an example of a w-BN superhard mill tools manufacturing process, according to some implementations of the present disclosure.

FIG. 18A is a schematic of an apparatus in which w-BN grits are synthesized from pure w-BN powder, according to some implementations of the present disclosure.

FIG. 18B is a schematic of a first-stage cube pressure booster device of the apparatus, according to some implementations of the present disclosure.

FIG. 19A is a block diagram showing examples of forces used to create w-BN grits from pure w-BN powder, according to some implementations of the present disclosure.

FIG. 19B is a drawing of an example of an octahedron produced by the apparatus, according to some implementations of the present disclosure.

FIG. 20 is a graph showing an example of a phase diagram identifying a narrow window for w-BN composition, according to some implementations of the present disclosure.

FIG. 21 is a graph showing an example of X-ray diffraction (XRD) results before and after an ultra-high-pressure, high-temperature (UHPHT) process, according to some implementations of the present disclosure.

FIG. 22 is a block diagram showing an example of a laser process for cutting bulk w-BN into smaller grit sizes, according to some implementations of the present disclosure.

FIG. 23 is a block diagram of an example of a vacuum chamber for powder and grit processing, according to some implementations of the present disclosure.

FIG. 24 is a schematic diagram of an example of a mixer for mixing w-BN grits with binder, according to some implementations of the present disclosure.

FIG. 25A is a flowchart of an example method for synthesizing a w-BN and cubic boron nitride (c-BN) compact for thermally spraying onto a tool substrate, according to some implementations of the present disclosure.

FIG. 25B is a flowchart of an example method for forming a tool for oil and gas applications using a synthesized w-BN and c-BN compact for thermally spraying onto a tool substrate, according to some implementations of the present disclosure.

FIG. 26 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for synthesizing (and coating tools with) a single-phase, pure, polycrystalline wurtzite boron nitride (w-BN) material. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

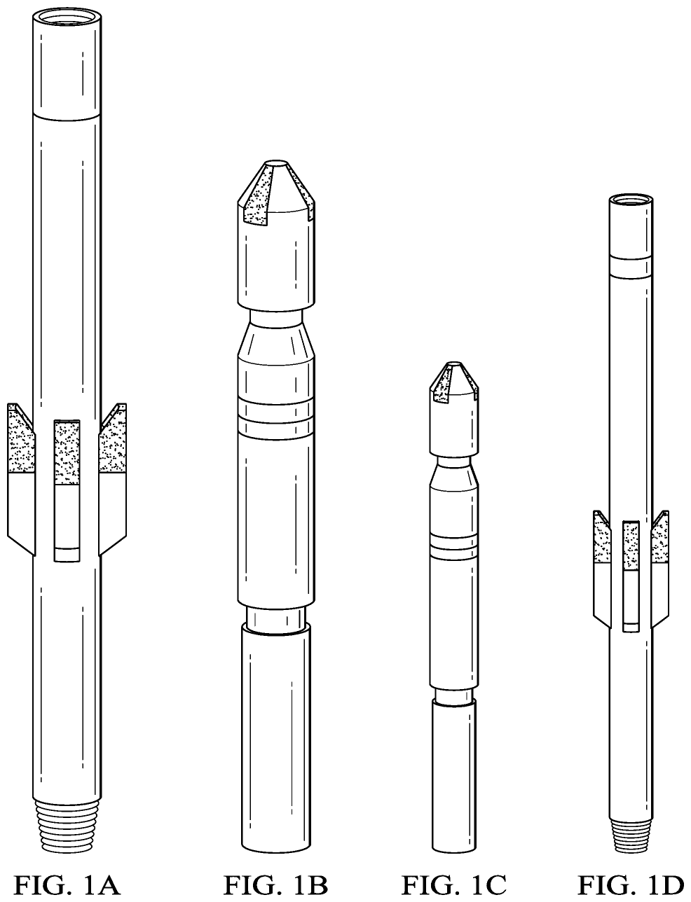

In some implementations, techniques can include an ultra-high-pressure, high-temperature (UHPHT) operation performed on pure w-BN powder to synthesize w-BN and c-BN grits (for example, greater than 20 microns) that are greater than particles of the powder. For example, the techniques can produce favorable results in a range of 10-20 gigapascals and a temperature range of 1100-1300° C. In particular, the UHPHT operation can include pressurizing the w-BN powder to a pressure of about 20 gigapascals (GPa) at heating rates of 100° C./minute (min) and cooling rates of 50° C./min. The resulting grits can be cut using laser cutting tools, sized by laser scanning, turbulently mixed with additives under vacuum in a mixer, and thermally sprayed onto a tool substrate to form the tool. The tool can be, for example, a milling tool or tools used in hydrocarbon exploration or production applications, such as related to oil and gas wells. Different types of mill tool features and their suitable applications are described with reference to FIGS. 1A-12.

FIGS. 1A-1D are diagrams showing examples of different types of packer-picker tools (or packer milling-retrieving tools), according to some implementations of the present disclosure. Packer picker tools are designed to mill and fish the packer and tailpipe in one drillstring run. The use of packer picker tools, for example, can save one drillstring trip. Further, millout extensions are not required to be in the packer for this type of tool.

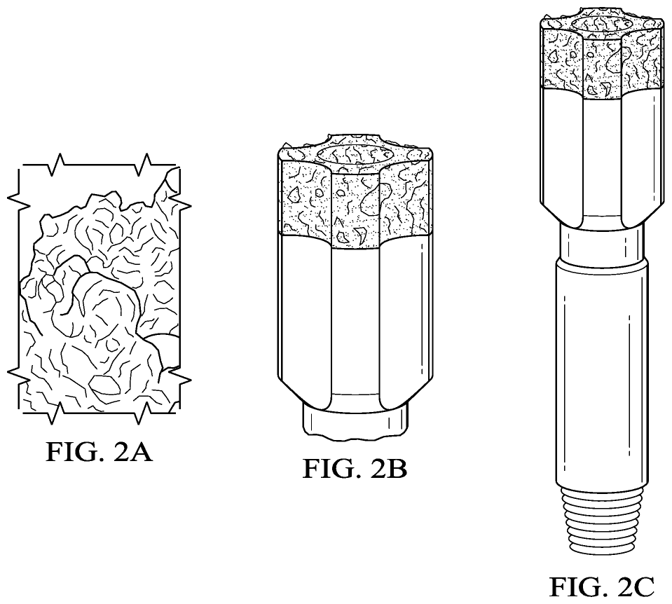

FIGS. 2A-2C are diagrams showing examples of different types of flat bottom mills, according to some implementations of the present disclosure. Flat bottom mills can be used for milling alloy-steel packers, squeeze tools, perforating guns, drill pipe, tool joints, reamers, reamer blades, and cement/rock bits. Flat bottom junk mills are ideal for dressing the top of a fish to make retrieval easier. Circulation ports and fluid channels provide optimal cooling and removal of cuttings. Maximum useful life is enhanced by the self-sharpening feature of flat-bottom mills.

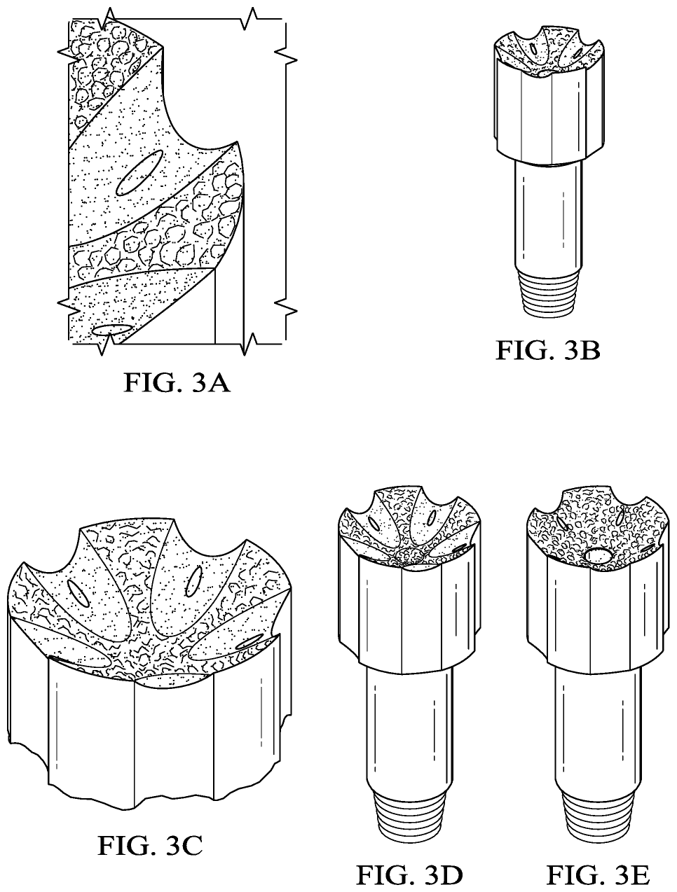

FIGS. 3A-3E are diagrams showing examples of different types of concave mills, according to some implementations of the present disclosure. Concave mills are designed to help keep bit cones or loose junk centered under the mill. Concave mills can be used for dressing the top of a fish to make retrieving easier. Concave mills can be constructed with rough tungsten carbide outside diameter (OD) or a smooth OD to prevent damaging the casing.

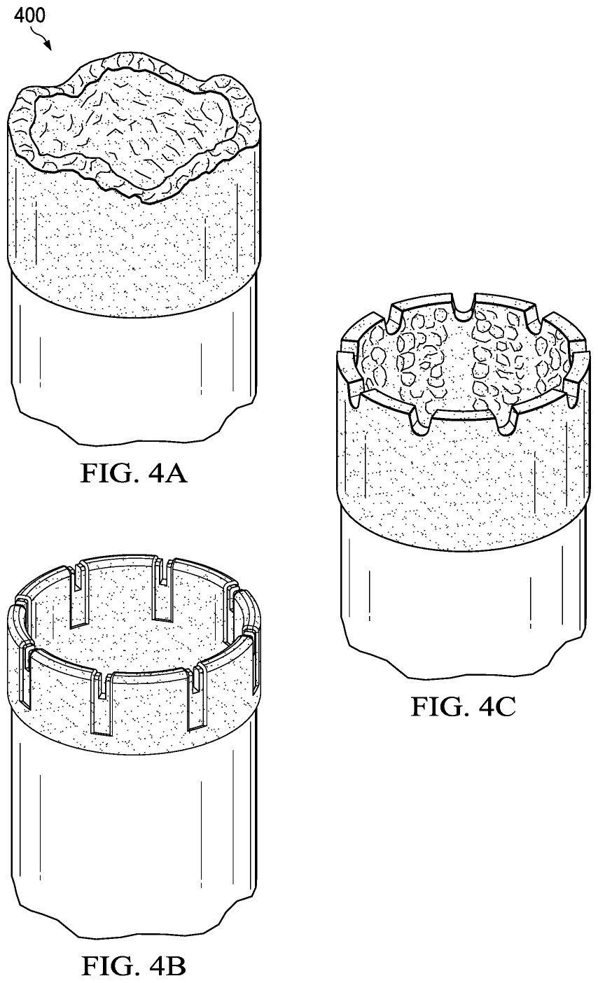

FIGS. 4A-4C are diagrams showing examples of different types of washover shoes, according to some implementations of the present disclosure. Washover shoes can be used to wash-over and free stuck pipes or other equipment left in a wellbore for removal from the well bore. Shoes can be connected to washover pipe, which can be produced in lengths of 30 to 32 feet, where the fish is cut and retrieved in stages. Washover systems can be designed and manufactured to suit each specific application based on the OD of the fish and clearance between the fish and the casing.

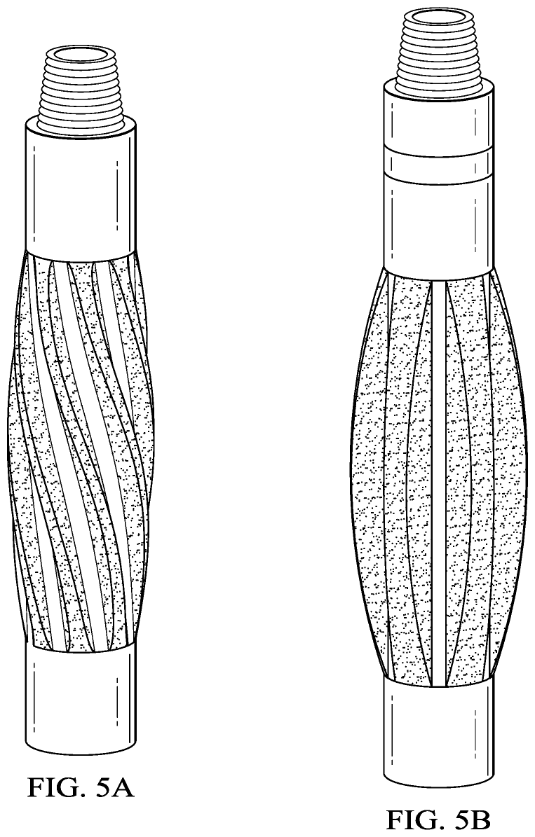

FIGS. 5A-5B are diagrams showing examples of different types of string mills or watermelon mills, according to some implementations of the present disclosure. String mills can primarily be used, for example, for drilling out tight spots inside of the casing right above a taper mill. String mills can also be used to smoothen whipstock windows for sidetracks. In open-hole application, string mills can be used for working through tight spots and doglegs in the formation.

FIG. 6 is a diagram showing an example of a taper mill, according to some implementations of the present disclosure. Taper mills can be used for opening collapsed casing, tubing, and the clean-up of scale build-up in the casing. The tapered shape of the taper mill can prevent milling through the tubing or casing and can provide self-centering in the bottom hole assembly (BHA). Taper mills can provide a low-torque cutting structure. Taper mills can be run on drill pipe or coiled tubing (for example, with a motor). Taper mills can have an angle that is based on the angle of the taper and length of the mill, such as a coiled tubing (CT) mill.

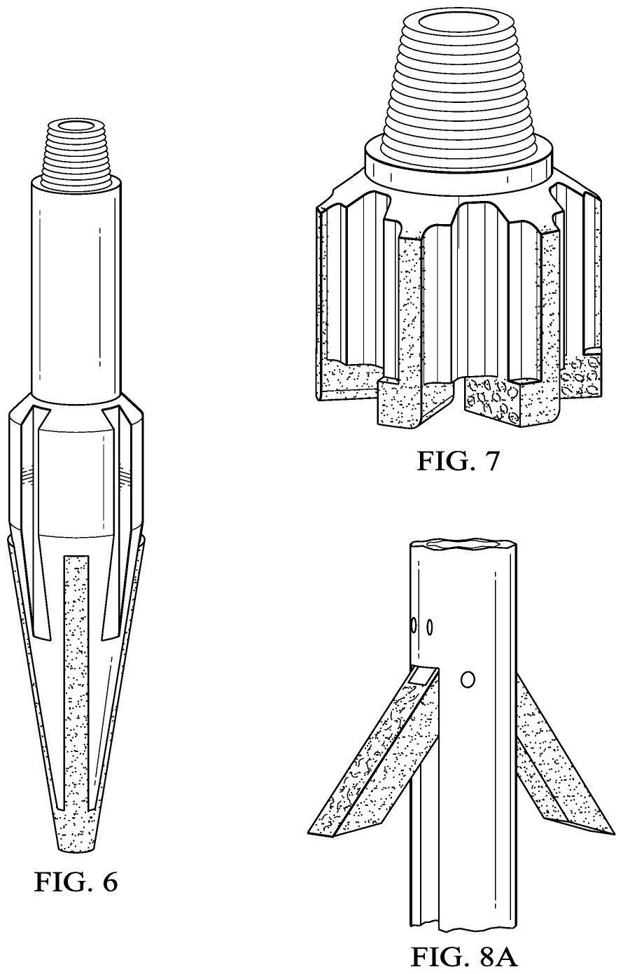

FIG. 7 is a diagram showing an example of a bladed mill, according to some implementations of the present disclosure. Bladed mills can be used to mill cement, tubing, bridge plugs, packers, downhole tools, pipe, and general junk for removal from the wellbore. Bladed mills can be used for cement milling, as bladed mills have fewer blades than non-cement-milling blades and greater flow passage areas than non-cement-milling blades to prevent clogging. A bladed mill with pilot can be used to mill long liners/casings.

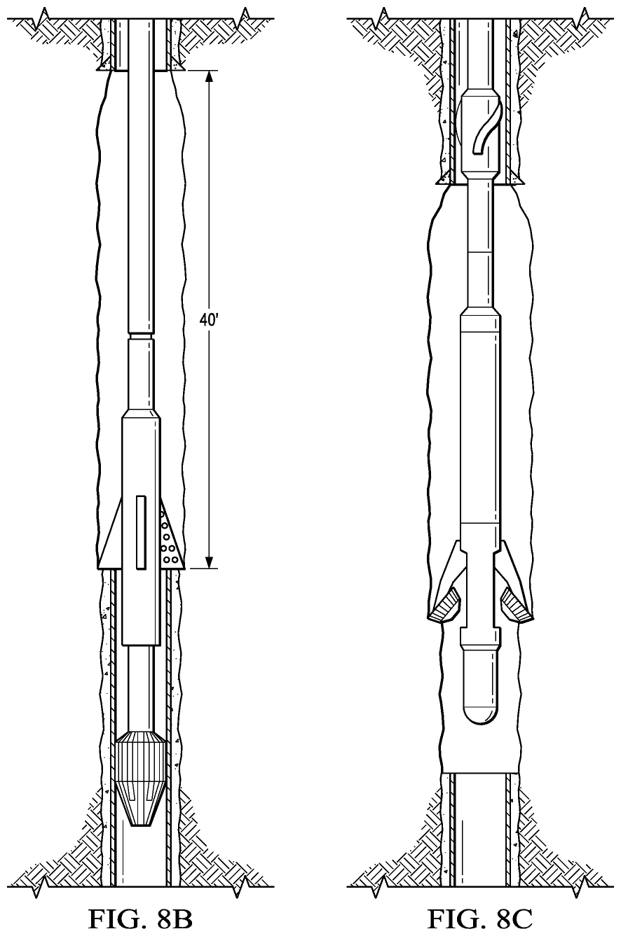

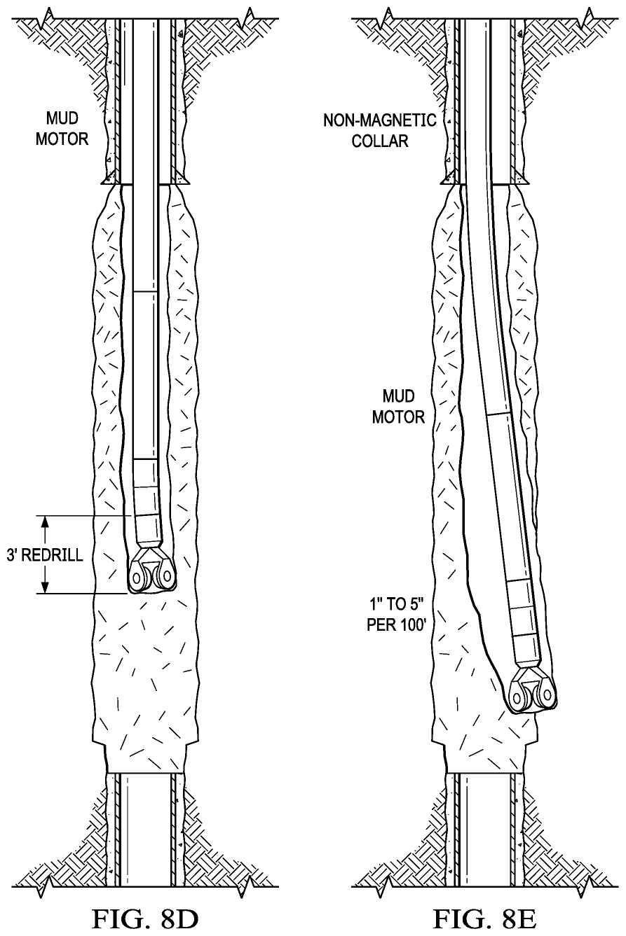

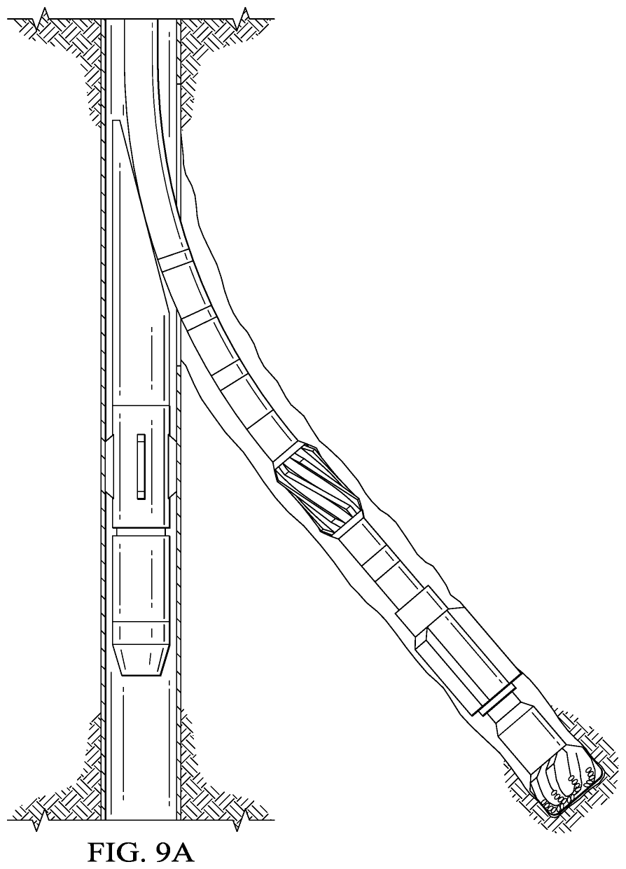

FIGS. 8A-8E are diagrams showing examples of different types of internal cutter/section milling tools, according to some implementations of the present disclosure. Bladed mills can be activated to cut and part the casing or section of casings or liners. Pilot mill can centralizes the internal cutter. Casings can be cut between connections, though it is advisable that no cut is made across the casing collars.

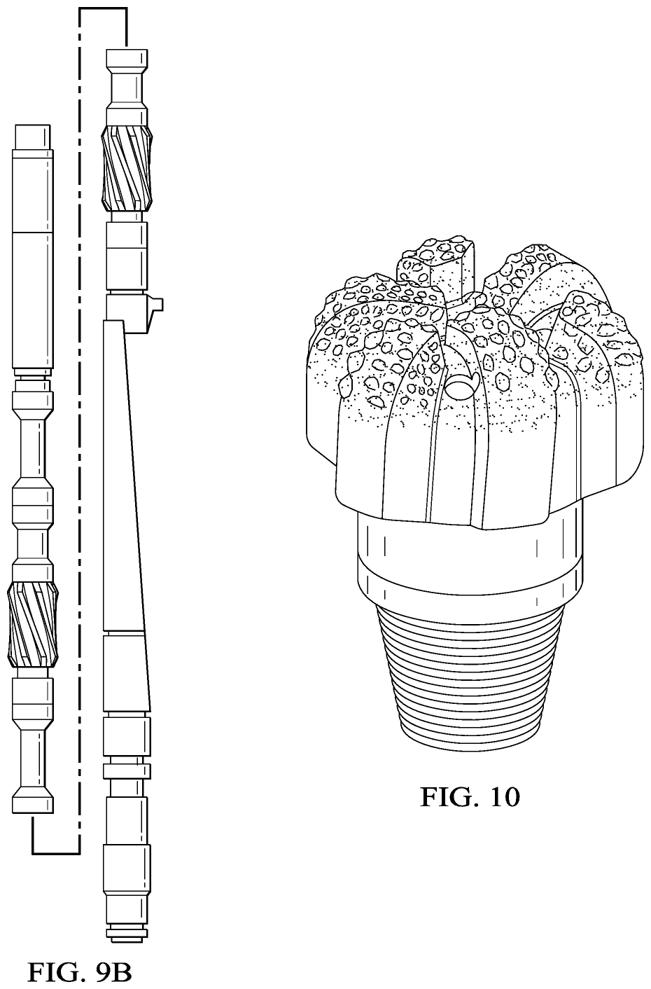

FIGS. 9A-9B are diagrams showing examples of different views of whipstock tools, according to some implementations of the present disclosure. Whipstock tools can be used in systems of mills, anchors, and optionally seal parts. Whipstock tools can be used to open a window for sidetracking inside cased hole. Types of whipstock tools include a cutting mechanism (for example, three-trip or single-trip) and a setting mechanism (for example, mechanical or hydraulic).

FIG. 10 is a diagram showing an example of an economill, according to some implementations of the present disclosure. For example, economills can be designed for milling packers, retainers, and bridge plugs, for drilling out cement, and for similar light-duty milling jobs. Economills can be included in best practices manual for cleaning out the shoetrack and the cement, particularly inside a 4-½″ liner.

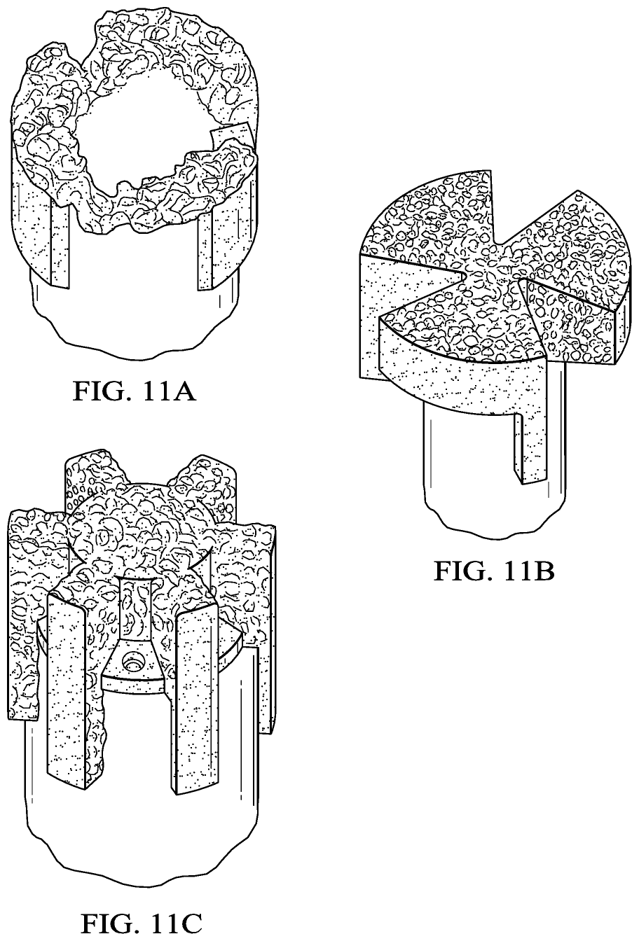

FIGS. 11A-11C are diagrams showing examples of different mill shapes, according to some implementations of the present disclosure. For example, mill tools can have different shape designs such as hollow mills, cobra mills, and muncher mills.

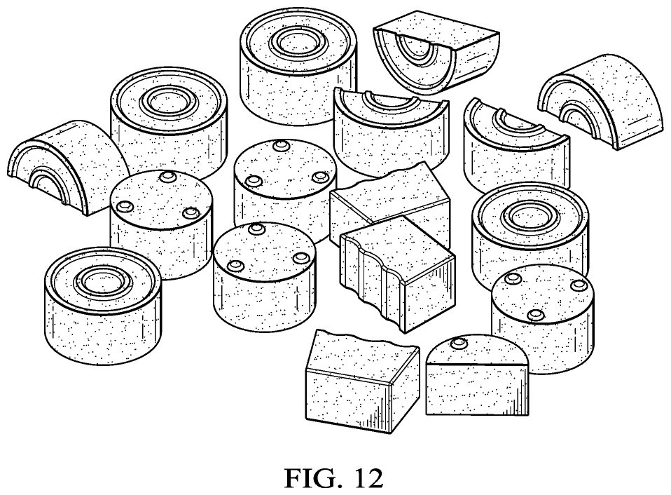

FIG. 12 is a diagram showing examples of different types of tungsten carbide inserts, according to some implementations of the present disclosure. For example, mill tools can be constructed using major milling material such as tungsten carbide (WC) with different morphologies such as the WC inserts shown in FIG. 12. Tungsten carbide (WC) is a compound of tungsten and carbon. Fine powders of tungsten carbide compound is pressed to form tungsten carbide ceramic using nickel (Ni) or cobalt (Co) as a binding material. Sometime tungsten carbide is also called an alloy; however in the pure form, tungsten carbide is a ceramic material. With the addition of cobalt or nickel, tungsten carbide behaves like metal and so it can be classified as a metallic material. The primary use of tungsten carbide for milling tool applications is as the cutting or milling parts. The Vickers hardness of tungsten carbide can range from 18 GPa to 20 GPa, depending on grain size.

In some implementations, milling tools can be manufactured with catalyst-free, superstrong BN materials made using ultra-high-pressure, high-temperature (HPHT) technology. Manufacturing processes can include designing a two-stage multi-anvil apparatus. The apparatus can be based on cubic press equipment with innovative pressure/temperature media and new high-pressure assemble ratios (for example, octahedron edge length or truncated edge length) for generating ultra-high pressures up to 35 GPa and high temperatures up to 2,000° C.

Manufacturing processes can use different forms of boron nitride, a material which crystallizes in hexagonal, cubic, and wurtzitic structures. Hexagonal boron nitride (h-BN) is a stable phase at ordinary temperature and pressure. Cubic boron nitride (c-BN) and wurtzitic boron nitride (w-BN) can be synthesized at ultra-high pressure and high temperature. Cubic boron nitride (c-BN) cutting tools have been developed mainly for finishing applications to hardened steel, chilled cast iron (Fe), and 35 Rockwell Hardness Scale C (HRC) or more of cobalt and nickel-based superalloys. However, cubic boron nitride cutting tools can present limitations on the use in workover milling due to more brittleness stemming from less strength and toughness. Being different from c-BN, w-BN has a toughness and strength greater than c-BN, making w-BN suitable for cutting or milling various materials such as a variety of hardened steel (for example, carbon tool steel, alloy tool steel, high-speed steel, bearing steel, and tool steel), chilled cast iron, cobalt- and nickel-based high-temperature alloys, tungsten carbide, surface coating (solder) materials, titanium alloys, pure nickel, and pure tungsten that can be encountered in workover milling applications. A certain amount of information has been reported concerning the mechanical properties of c-BN, in particular its hardness, which is equal to 45-50 GPa. However, virtually nothing is known as yet about the mechanical properties of the w-BN, as wurtzite is a metastable phase of BN at all pressures and temperatures and wurtzite is difficult to prepare as a pure phase. Several results suggest that w-BN may be as hard or harder than diamond, even while w-BN and c-BN have a similar bond length, elastic moduli, ideal tensile, and shear strength.

In experiments associated with the present disclosure, high purity w-BN and c-BN compact (for example, over 99% pure) were successfully synthesized from w-BN powder under ultra-high pressure (for example, a pressure of approximately 20 gigapascals) and high temperature (for example, in the range of 1100-1300° C.), and the compact microstructure and thermal stability were investigated. The w-BN powders were used as starting materials after a vacuum heat-treatment at 400° C. The majority of experiments were performed using a two-stage (6-8 system) multi-anvil apparatus. The pressure was calibrated by means of the well-known pressure-induced phase transitions and the cell temperature was measured directly using a Tungsten-Rhenium (W-Re) 3% to 25% Rhenium content thermocouple. Wurtzitic boron nitride powder was compressed to a pressure of 20 GPa and heated with a heating rate of 100° C./min to the desired value. The duration of heating was 30 min. The samples were quenched to an ambient temperature with a cooling rate of about 50° C./min and then decompressed to ambient pressure.

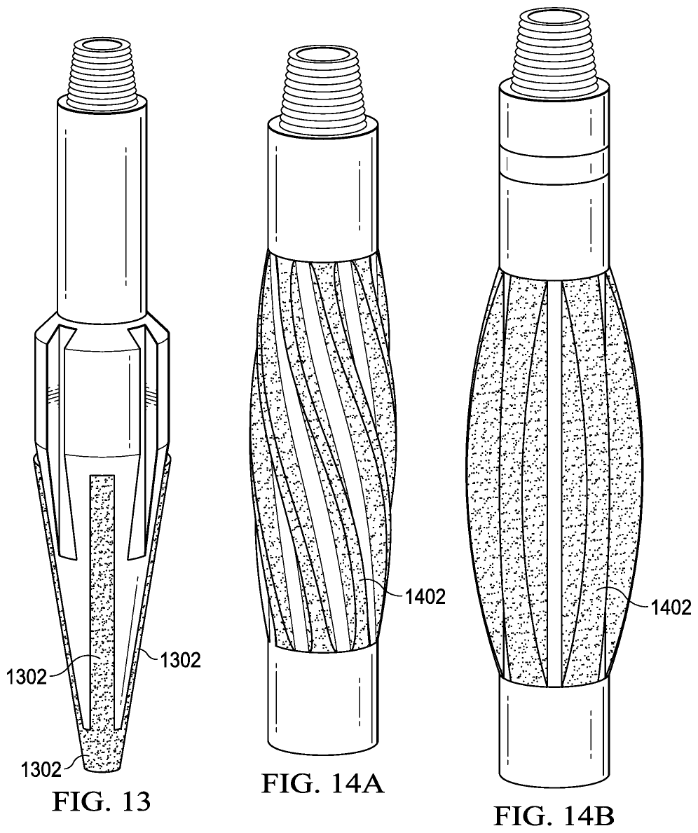

FIG. 13 is a diagram showing an example of a tape mill tool designed and made from superstrong wurtzitic boron nitride (w-BN) material, according to some implementations of the present disclosure. For example, a tape mill designed using the w-BN superhard material can include w-BN grit 1302 that is attached either by thermal spraying technology or laser printing.

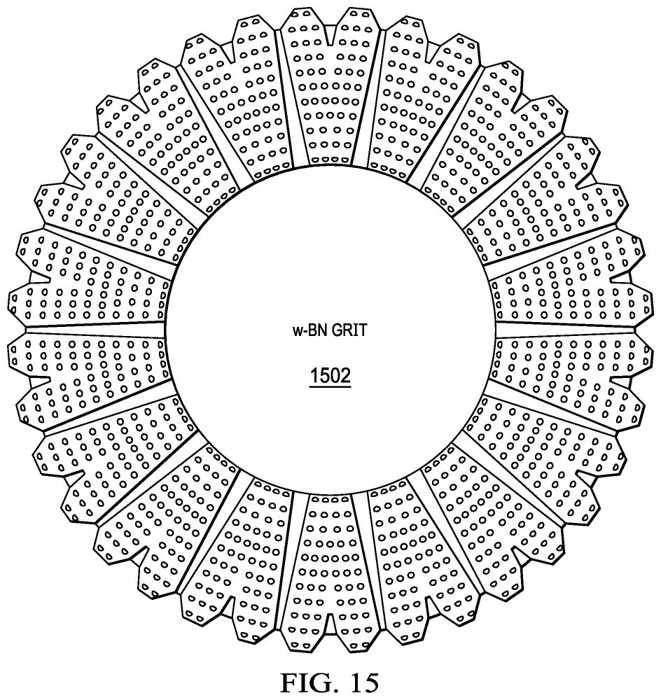

FIGS. 14A-14B are diagrams showing examples of a new string mill tool made from thermal sprayed w-BN superhard material, according to some implementations of the present disclosure. For example, a string mill tool can be made by bonding w-BN superhard material, such as a w-BN coating 1402, to the mill tool attached either by thermal-spraying coating technology or by laser printing.

FIG. 15 is a diagram showing an example of a ring mill tool made that includes attached or bonded w-BN superhard grit material 1502, according to some implementations of the present disclosure. For example, the w-BN superhard (for example, at least 60 GPa) grit material can be bonded to the mill tool attached either by welding or by laser printing.

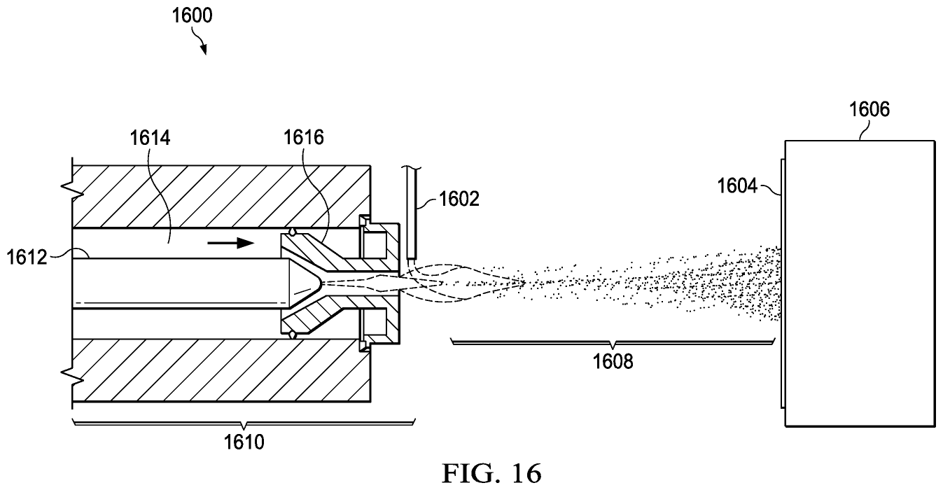

FIG. 16 is a diagram showing an example of a plasma spraying coating technology process 1600, according to some implementations of the present disclosure. For example, the process 1600 can include w-BN injection 1602 that provides a coating 1604 on a mill body 1606. The w-BN injection 1602 can provide a spray stream of w-BN grits 1608, for example. An injection system 1610 can include a cathode 1612 for providing negatively-charged w-BN material, plasma gas 1614 to mix with the w-BN material, and an anode 1616 to charge particles of the w-BN leaving the injection system 1610.

The injection system 1610 can be used for coating w-BN superhard mill tools by providing thermal plasma spraying to milling tools. From starting pure w-BN powder, the bulk w-BN superhard materials can be synthesized by ultra-high pressure and high temperature. Laser technology can be applied to make w-BN grit or small particles which can be mixed or blended with bonder such as Co or nickel (Ni) alloys. Thermal spraying coating technology can be used to attach the w-BN to the milling tools.

Thermal spraying techniques can include coating processes in which melted (or heated) materials are sprayed onto a surface that improves or restores the surface of a solid material. Coating processes can be used to apply coatings to a wide range of materials and components. A coating can provide resistance to wear, erosion, cavitation, corrosion, abrasion, or heat, for example. A feedstock (or coating precursor) can be heated by electrical techniques (for example, plasma or arc), chemical techniques, or a combustion flame. Thermal spraying can also be used to provide surface properties such as electrical conductivity or insulation, lubricity, high friction (for example, more than a pre-determined coefficient of friction (CoF)), low friction (for example, less than a pre-determined CoF), sacrificial wear, and chemical resistance. Thermal spraying is widely adopted across many industries as a preferred method. Thermal spraying can extend the life of new components and can be used to repair or re-engineer worn or damaged components. The present disclosure describes techniques by combining new superhard w-BN grits synthesized using UHPHT technology with binders to form strong milling tools.

Binder materials provide a critical role in coating strength. Binder materials can include Fe, Co, and Ni or their alloys. Binders can also include refractory metals and alloys such as tungsten alloys, tantalum (Ta), molybdenum (Mo), and niobium (Nb). Active brazing alloys (ABAs) can also be used as binders for joining ultra-strong polycrystalline diamond compacts (PDC) cutters. Active metal brazing can allow the bonding of superhard PDC cutting materials directly to WC/Co substrate composites without metallization, thereby eliminating several steps in the joining process and creating a hermetic seal capable of reaching greater operating temperatures than non-active-metal-brazing techniques. Active metal brazing can be used with any combination of ceramics, carbon, graphite, metals, and diamond. Active metal brazing can facilitate the joining of WC/Co and PDC materials and components, which is beneficial in oil industry applications.

Thermal spraying can provide thick coatings, for example, with an approximate thickness range of 20 microns to several millimeters (mm). Thickness can depend on processes and feedstock, such as processes over a greater area and at a high deposition rate as compared to other coating processes such as physical vapor deposition (PVD) and chemical vapor deposition (CVD). Coating materials available for thermal spraying can include superhard w-BN materials (as described in the present disclosure), such as metals, alloys, ceramics, plastics, and composites.

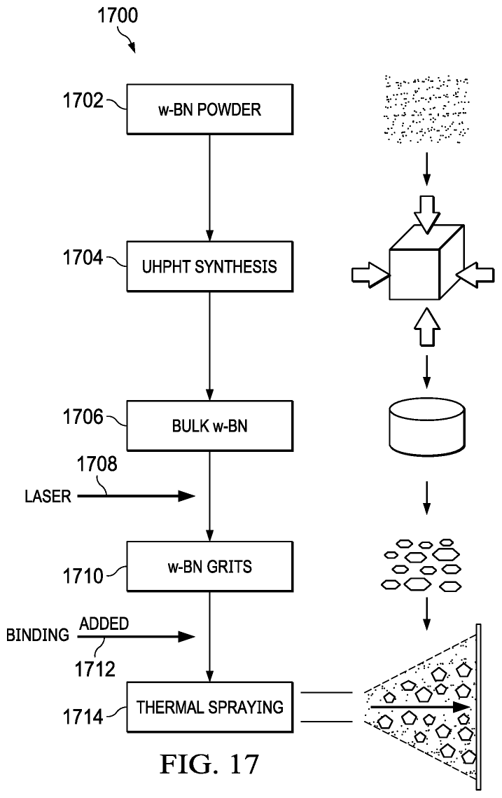

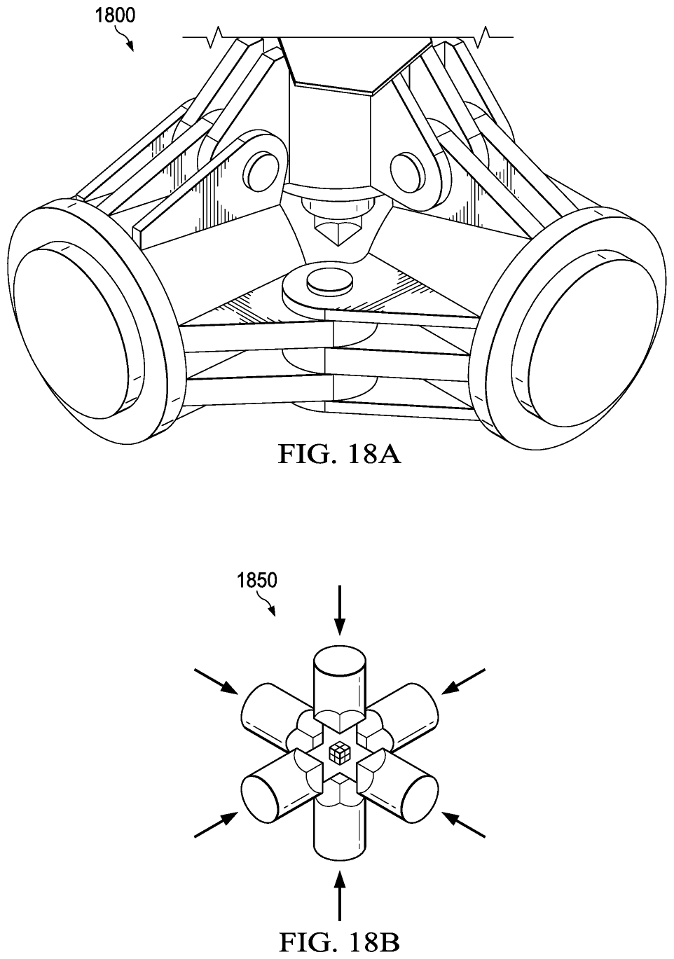

FIG. 17 is a flow diagram showing an example of a w-BN superhard mill tools manufacturing process 1700, according to some implementations of the present disclosure. The process 1700 can begin with the production of a w-BN powder 1702. At 1704, UHPHT synthesis can be used to create greater-sized solids from the w-BN powder. At 1706, the greater-sized solids can be used to create bulk w-BN. A laser 1708 can be used to create w-BN grits 1710 from the bulk w-BN. At 1714, after binding 1712 is added to the w-BN grits, thermal spraying can be used to attach the bulk w-BN grits to tools.

The w-BN superhard mill tools manufacturing process 1700 can use a w-BN powder or grit form, heated to a binder molten or semi-molten state and accelerated toward milling tool substrates in the form of micrometer-size particles. Combustion or electrical arc discharge is usually used as the source of energy for thermal spraying. Resulting coatings can be made by the accumulation of numerous sprayed w-BN particles. The coating quality can increase by increasing particle velocities. Variations of thermal spraying can include, for example, plasma spraying, detonation spraying, wire arc spraying, flame spraying, high-velocity oxy-fuel coating spraying (HVOF), high-velocity air fuel (HVAF), warm spraying, and cold spraying.

FIG. 18A is a schematic of an apparatus 1800 in which w-BN grits are synthesized from pure w-BN powder, according to some implementations of the present disclosure. FIG. 18B is a schematic of a first-stage cube pressure booster device 1850 of the apparatus 1800, according to some implementations of the present disclosure. The apparatus 1800 can also include a second-stage octahedral pressure booster device used in a process to convert cubes to octahedra.

The first-stage cube pressure booster device 1850 can provide a primary pressure cavity formed by six anvil-shaped square carbide alloy anvils. The hydraulic cylinders can be pushed forward across three axes, together forming a cubic pressure chamber. The second-stage octahedral pressure booster device can include eight angled squares of WC-Co cemented carbide (or end-stage anvils), forming an eight-sided high-pressure cavity inside which the pressure media are placed. At an end-stage of the anvil propulsion, the eight-faced medium is pressured (for example, rheologically deformed) to produce a sealing edge, with the end anvil faces forming the second-stage ultra-high-pressure chamber.

In some implementations, assembly features of the second-stage pressure chamber of a large cavity static high-pressure device can include the following. Assembly can result in a length, a, of the eight-sided pressure media (for example, 1 mm) and the end-stage anvil truncation length, b, where a/b can be a design feature of the whole system design. The parameters can reflect the assembly of the basic structure of the two-stage pressure chamber and the approximate size of the sample that can be produced.

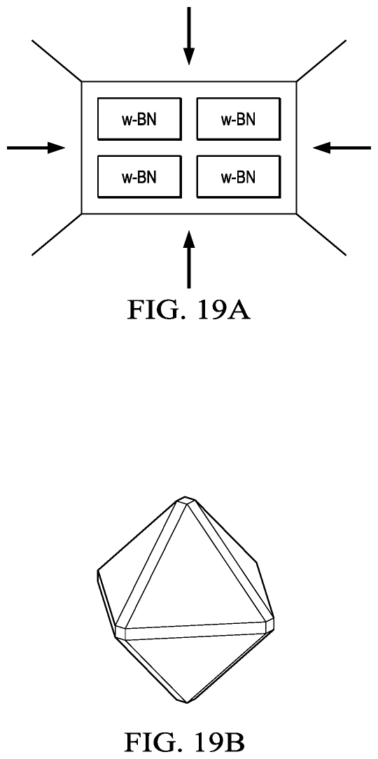

FIG. 19A is a block diagram showing examples of forces used to create w-BN grits from pure w-BN powder, according to some implementations of the present disclosure. FIG. 19B is a drawing of an example of an octahedron produced by the apparatus 1800, according to some implementations of the present disclosure. In some implementations, techniques can be used for laser scanning to cut bulk w-BN to produce grits. Binder can be added to the grits of smaller sizes, such as by blending the binder and the grits using turbulent mixing under vacuum. In some implementations, powder or particle blending or mixing techniques can include the use of laminates or turbulence. Turbulent blending may be better suited for w-BN particle combination. For example, a rotary mixer can be configured in a double conical or V-shaped configuration. In some implementations, configuration geometries can be used that have asymmetries that reduce mixing time and improve mixing uniformity. Mixers using such configuration geometries, for example, can operate at 5 to 25 revolutions per minute, with filling levels ranging from 50% to 75%.

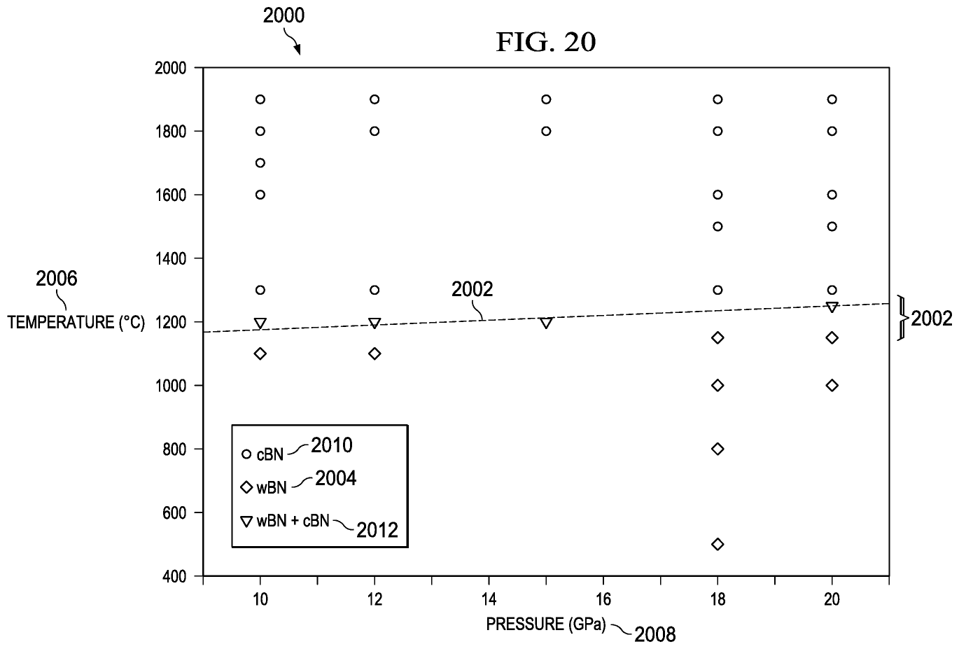

FIG. 20 is a graph showing an example of a phase diagram 2000 identifying a narrow window 2002 for w-BN 2004 composition, according to some implementations of the present disclosure. As shown in the phase diagram 2000, the window for w-BN 2004 composition is narrow as a combination of temperature 2006 and pressure 2008. Outside of the window, it is difficult to produce w-BN 2004. For example, c-BN 2010 is produced at temperatures 2006 greater than temperatures in the window, and w-BN+c-BN 2012 is produced at temperatures 2006 less than temperatures in the window. The w-BN bulk material can be made from the w-BN startup powder. The maximum pressure of traditional HPHT processes (such as diamond grits synthesis and PDC Cutters) is typically limited to 8 GPa due to graphite heater problems. This is because, at a pressure exceeding 8 GPa, the conductive graphite heater will lose its function by converting to insulated diamond. When the pressure exceeds 10 GPa, UHPHT conditions are created that requires special pressure cell design and new heater materials. It is not simple to increase the pressure from the 10 GPa to 20 GPa by the traditional HPHT technology to make the w-BN. However, UHPHT devices can make w-BN from 10 GPa to 20 GPa. Experimentation has found that a slow heating speed improves the quality of sintering specimens. Because the w-BN is converted to c-BN, the slow heating rate can lead to the microstructure of the long rod. When the heating rate increases, the grain size increases rapidly, and the hardness decreases.

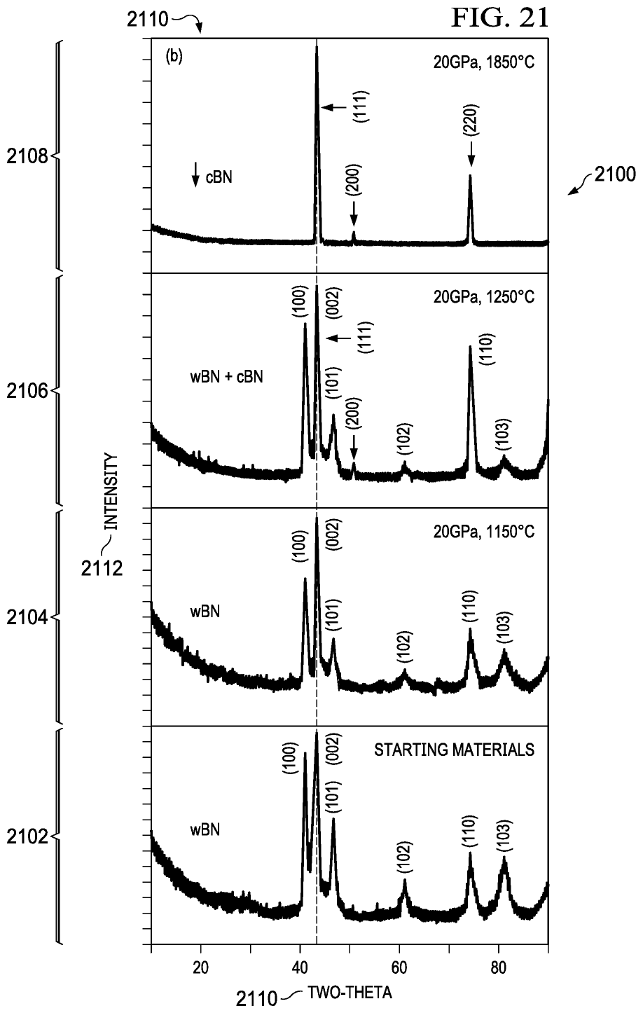

FIG. 21 is a graph 2100 showing an example of X-ray diffraction (XRD) results before and after an ultra-high-pressure and high-temperature (UHPHT) process, according to some implementations of the present disclosure. The phase composition of the sintered samples was investigated by XRD analysis with CuKα radiation. The investigation showed that a pure single phase w-BN was successfully synthesized.

The graph 2100 includes subgraphs 2102, 2104, 2106, and 2108 relative to a theta value 2110 on the x-axis and an intensity 2112 on the y-axis. The subgraphs 2102, 2104, 2106, and 2108 plot intensity values for w-BN starting materials, w-BN at 20 GPa and 1150° C., w-BN+c-BN at 20 GPa and 1250° C., and c-BN at 20 GPa and 1850° C., respectively.

To obtain the graph 2100, microstructures of sintered samples were characterized using scanning electron microscopy (SEM). Vickers hardness of the polished samples was tested with different applied loading forces and a fixed indenting time of 15 s by a Vickers hardness tester. The thermal gravimetric analysis (TGA) was carried out in air with a heating rate of 10° C./min from 30° C. to 1400° C.

The Vickers hardness of the w-BN compact was determined to be approximately 60 GPa—three times harder than currently used WC mill tools. The onset oxidation temperature of 920° C. in air was much greater than diamond and WC. This generation of UHPHT w-BN material that is completely different from conventional WC material can provide improved performance in terms of wear resistance, impact tolerance, and thermal stability conductivity. Enhanced run life can be expected with new milling tools having these new milling w-BN materials. Due to the improved performance of the new superstrong w-BN material, the new milling tools can be designed to have the least thickness and smallest dimensions to surpass all current milling materials in terms of reliability, lifetime, and cost-effectiveness.

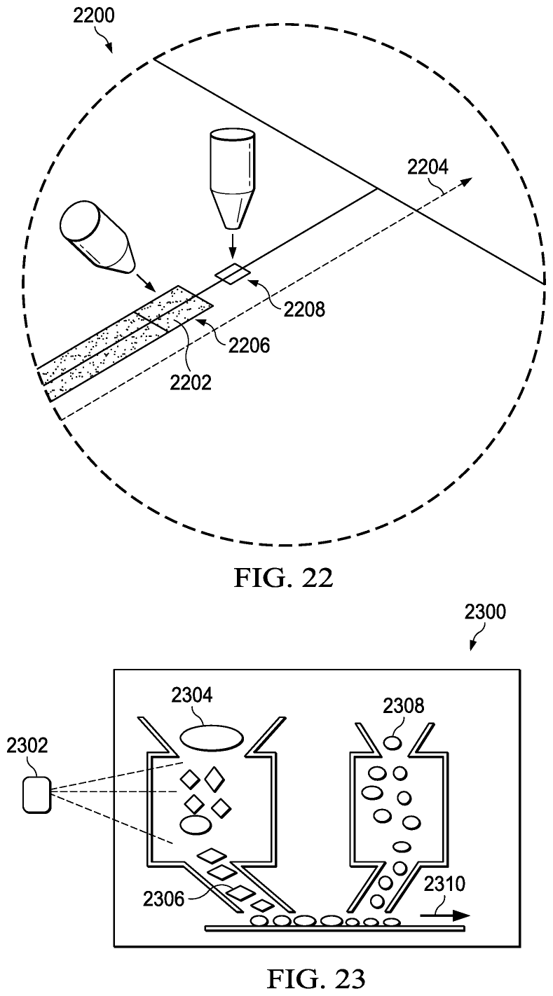

FIG. 22 is a block diagram showing an example of a laser process 2200 for cutting bulk w-BN into smaller grit sizes, according to some implementations of the present disclosure. The example, the laser process 2200 can be used to cut w-BN blanks 2202 which are processed in a cutting path 2204. In some implementations, the laser process 2200 can use laser cutting technology that injects water at a water-jet spot 2206 and uses at least one laser at a laser spot 2208. Placement of the laser(s) can determine w-BN grit size characterization. Different ranges of grit sizes can be used mixing with a binder. The process 2200 can be repeated, first with laser cutting and then laser scanning. For example, if grit sizes are in the desired size ranges, then mixing or blending can occur. Otherwise, laser cutting can be repeated until the grits are in a particular grit size range. The process 2200 can include laser cutting and laser scanning that occur in parallel or sequentially.

In some implementations, w-BN grits and a binder can be mixed using turbulent mixing under a vacuum. For example, blades, paddles, or screw elements can be used to invert powders, in which case a large amount of material is moved from one place to another in a 360-degree rotation. In some implementations, the grits can be sorted by size prior to mixing with binder. For example, particle or grit size distribution measurements can be done using a laser diffraction and scatting method. The w-BN grits and the binder can be transported from a cutting chamber to the mixer using separate funnel valves. Mixing chambers can be implemented as fluidized bed reactor, where turbulent mixing can include spinning rates from 100 to 1000 revolutions per minute (rpm). Mixing under the vacuum can help to reduce impurities that may have been introduced during the cutting process.

Laser cutting technology that is used to cut bulk w-BN into smaller sizes can include the use of a continuous wave CO₂ laser that is combined with other heat sources, such as plasma, electron beam, and a water jet, to improve the processing efficiency and quality of BN. For example, CO₂-water jet processing systems can realize high power laser heating, followed by low-pressure water jet quenching (for example, at the water-jet spot 2206), which can realize the fracture start and can control propagation along the cutting path. Laser water-jet processing techniques can use a completely different mechanism from traditional laser processing to remove material by melting and ablation. For example, by controlling crack propagation, the material separation can be realized and the speed can be faster than non-laser water-jet processing techniques, with no thermal impact zone. In conventional systems, main sources of fracture propagation typically are laser rapid heating and thermal stress caused by water-jet quenching on the surface of samples in ceramic cutting, with low thermal conductivity, such as using aluminum nitride (AlN). In the cutting process of high-thermal-conductivity BN, the temperature gradient can be insignificant (for example, without providing additional thermal stress). A major consideration of BN processing is the stress caused by the change of the volume of the converted material. The volume change can trigger the tensile stress field in the transformation area, which can induce the expansion and separation of the initial crack of the material in the whole thickness.

FIG. 23 is a block diagram of an example of a vacuum chamber 2300 for powder and grit processing, according to some implementations of the present disclosure. For example, the vacuum chamber 2300 can be used with 3D laser scanning 2302 in a process used to convert physical objects into precise digital models. Inside the vacuum chamber 2300, bulk w-BN 2304 can be scanned and cut into w-BN grits 2306. An active binder feed 2308 can supply binder funneled and combined with the w-BN grits 2306 for blending 2310. Blended w-BN grits 230 and binder can he provided to a thermal spraying feedstock. The 3D laser scanning can enable fast and accurate capture of an object's shape and geometries, for example. Particle sizing by laser diffraction can be used as a particle sizing technique for producing particles in the range of 0.5 to 1000 microns. Laser diffraction works on the principle that when a beam of light (a laser) is scattered by a group of particles, the angle of light scattering is inversely proportional to particle size. For example, using smaller particle sizes can increase the angle of light scattering. The use of 3D laser scanning and laser diffraction can be used to filter grits by size, including identifying grits that are too large or too small. If laser scanning reveals that a grit is too large or too small (for example, outside the range of 0.5 to 1000 microns), then the grit can be prevented from being transported to the additive blender. Grits that are within the size range can be transported to an additive blender, while grits that are too large can be re-cut using a serving process.

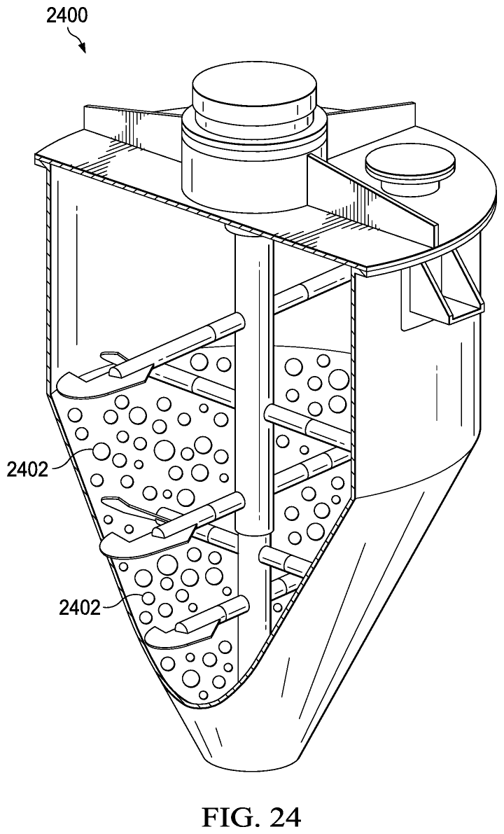

FIG. 24 is a schematic diagram of an example of mixer 2400 for mixing w-BN grits 2402 with binder, according to some implementations of the present disclosure. The mixer 2400 can include blades, paddles, or screw elements to invert powders and move large amounts of material into multiple places in the mixer 2400 in a 360-degree rotation. The mixer 2400 can be used for mixing powders, granules, and solids with liquids. A conical paddle mixer configuration of the mixer 2400 can provide high accuracy and fast mixing with limited product distortion.

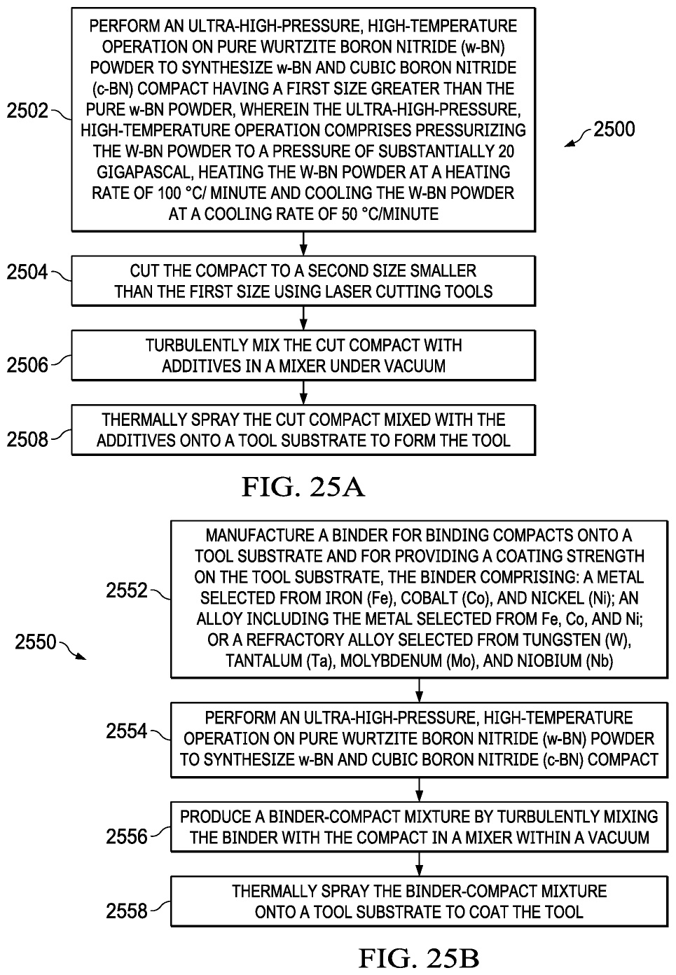

FIG. 25A is a flowchart of an example method 2500 for synthesizing a w-BN and cubic boron nitride (c-BN) compact for thermally spraying onto a tool substrate, according to some implementations of the present disclosure. For clarity of presentation, the description that follows generally describes method 2500 in the context of the other figures in this description. However, it will be understood that method 2500 can be performed, for example, by any suitable system, environment, software, and hardware, or a combination of systems, environments, software, and hardware, as appropriate. In some implementations, various steps of method 2500 can be run in parallel, in combination, in loops, or in any order.

At 2502, an ultra-high-pressure, high-temperature (UHPHT) operation is performed on pure w-BN powder to synthesize a w-BN and cubic boron nitride (c-BN) compact having a first size greater than particles of the pure w-BN powder. The compact can have an octahedron shape, for example, as shown in FIG. 19B. The ultra-high-pressure, high-temperature operation includes pressurizing the w-BN powder to a pressure of approximately 20 GPa, heating the w-BN powder at a heating rate of 100° C./min and cooling the w-BN powder at a cooling rate of 50° C./min. For example, the apparatus 1800 can be used to synthesize w-BN grits from pure w-BN powder. From 2502, method 2500 proceeds to 2504.

At 2504, the compact is cut to a second size smaller than the first size using laser cutting tools. As an example, can be cut into smaller sizes using a laser, as described with reference to FIG. 22.

In some implementations, method 2500 can further includes steps for re-cutting cut compact into smaller pieces. Pieces of the cut compact having a size greater than a threshold size of a size range can be identified, such as by using laser scanner to measure the pieces. The pieces of the cut compact having the size greater than the threshold size are then re-cut using the laser cutting tools.

In some implementations, method 2500 can further include cooling the compact with a cooling liquid during a cutting process that includes the cutting. For example, water-jets at a water-jet spot 2206 can be used to cool the w-BN blank during the cutting process. From 2504, method 2500 proceeds to 2506.

At 2506, the cut compact is turbulently mixed with additives in a mixer under vacuum. For example, the mixer 2400 can be used to mix w-BN grits with an additive that is added through the active binder feed 2308. The additives can include at least one binder for binding the cut compact onto the tool substrate. From 2506, method 2500 proceeds to 2508.

At 2508, the cut compact mixed with the additives is thermally sprayed onto a tool substrate to form the tool. For example, the plasma spraying coating technology process 1600, including the w-BN injection 1602, can provide the coating 1604 on the mill body 1606. Other tools and surfaces that can be coated are described with reference to FIGS. 1A-15. After 2508, method 2500 can stop.

In some implementations, method 2500 can further include determining a pressure and temperature window at which the ultra-high-pressure, high-temperature operation forms the compact. For example, experimentation, repeated measurements, and repeated analysis can determine the narrow window 2002 for w-BN 2004 composition. As shown in the phase diagram 2000, the window for w-BN 2004 composition is narrow as a combination of pressure 2006 and pressure 2008. Then, ultra-high-pressure, high-temperature operations that are executed can be conducted to focus on pressure and temperature conditions within the narrow window 2002.

FIG. 25B is a flowchart of an example method 2550 for forming a tool for oil and gas applications using a synthesized w-BN and cubic boron nitride (c-BN) compact for thermally spraying onto a tool substrate, according to some implementations of the present disclosure. For clarity of presentation, the description that follows generally describes method 2550 in the context of the other figures in this description. However, it will be understood that method 2550 can be performed, for example, by any suitable system, environment, software, and hardware, or a combination of systems, environments, software, and hardware, as appropriate. In some implementations, various steps of method 2550 can be run in parallel, in combination, in loops, or in any order.

At 2552, a binder is manufactured for binding a cut compact onto a tool substrate and providing a coating strength on the tool substrate. In some implementations, the binder can include, for example, a metal selected from iron (Fe), cobalt (Co), and nickel (Ni); an alloy including the metal selected from Fe, Co, and Ni; or a refractory alloy selected from tungsten (W), tantalum (Ta), molybdenum (Mo), and niobium (Nb). The binder can be used for coating the tools and surfaces described with reference to FIGS. 1A-15, for example.

In some implementations, the binding can include an active brazing alloy (ABA) used for coating ultra-strong polycrystalline diamond compact (PDC) cutters, where active metal brazing using the ABA bonds superhard PDC cutting materials directly to tungsten carbide cobalt (WC/Co) substrate composites without metallization, and where the active metal brazing eliminates steps in a joining process and creates a strong, hermetic seal resistant to greater operating temperatures. Active metal brazing can be used with any combination of ceramics, carbon, graphite, metals, and diamond. Active metal brazing can facilitate the joining of WC/Co and PDC materials and components, which is beneficial in oil industry applications.

In some implementations, the compact has a first size greater than particles of the pure w-BN powder. The ultra-high-pressure, high-temperature operation can include, for example, pressurizing the pure w-BN powder to a pressure of approximately 20 gigapascals; heating the pure w-BN powder at a heating rate of 100° C./minute; and cooling the pure w-BN powder at a cooling rate of 50° C./minute. From 2552, method 2550 proceeds to 2554.

At 2554, an ultra-high-pressure, high-temperature operation is performed on pure wurtzite boron nitride (w-BN) powder to synthesize w-BN and cubic boron nitride (c-BN) compact. As an example, the apparatus 1800 can be used to synthesize w-BN grits from pure w-BN powder. From 2554, method 2550 proceeds to 2556.

At 2556, a binder-compact mixture is produced by turbulently mixing the binder with the compact in a mixer within a vacuum. For example, the mixer 2400 can be used to mix w-BN grits with an additive that is added through the active binder feed 2308. From 2556, method 2550 proceeds to 2558.

At 2558, the binder-compact mixture is thermally sprayed onto a tool substrate to coat the tool. For example, the plasma spraying coating technology process 1600, including the w-BN injection 1602, can provide the coating 1604 on the mill body 1606. After 2558, method 2550 can stop.

In some implementations, method 2550 can further include cutting the compact to a second size smaller than the first size using laser cutting tools. Cutting the compact (for example, using multiple cuts) can result in an octahedron shape. During cutting, the compact can be cooled with a cooling liquid.

In some implementations, the cutting process can include identifying pieces of the compact having a size greater than a threshold size of a size range. In this example, the pieces can be recutting, using the laser cutting tools, the pieces of the compact greater in size than the threshold size.

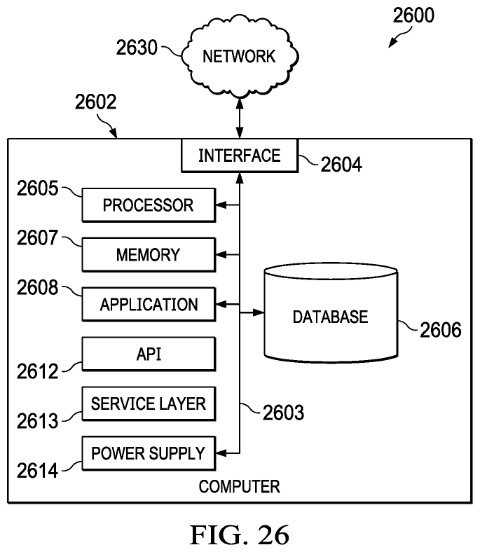

FIG. 26 is a block diagram of an example computer system 2600 used to provide computational functionalities associated with described algorithms, methods, functions, processes, flows, and procedures described in the present disclosure, according to some implementations of the present disclosure. The illustrated computer 2602 is intended to encompass any computing device such as a server, a desktop computer, a laptop/notebook computer, a wireless data port, a smartphone, a personal data assistant (PDA), a tablet computing device, or one or more processors within these devices, including physical instances, virtual instances, or both. The computer 2602 can include input devices such as keypads, keyboards, and touchscreens that can accept user information. Also, the computer 2602 can include output devices that can convey information associated with the operation of the computer 2602. The information can include digital data, visual data, audio information, or a combination of information. The information can be presented in a graphical user interface (UI or GUI).

The computer 2602 can serve in a role as a client, a network component, a server, a database, a persistency, or components of a computer system for performing the subject matter described in the present disclosure. The illustrated computer 2602 is communicably coupled with a network 2630. In some implementations, one or more components of the computer 2602 can be configured to operate within different environments, including cloud-computing-based environments, local environments, global environments, and combinations of environments.

At a high level, the computer 2602 is an electronic computing device operable to receive, transmit, process, store, and manage data and information associated with the described subject matter. According to some implementations, the computer 2602 can also include, or be communicably coupled with, an application server, email server, web server, caching server, streaming data server, or a combination of servers.

The computer 2602 can receive requests over network 2630 from a client application (for example, executing on another computer 2602). The computer 2602 can respond to the received requests by processing the received requests using software applications. Requests can also be sent to the computer 2602 from internal users (for example, from a command console), external (or third) parties, automated applications, entities, individuals, systems, and computers.

Each of the components of the computer 2602 can communicate using a system bus 2603. In some implementations, any or all of the components of the computer 2602, including hardware or software components, can interface with each other or the interface 2604 (or a combination of both), over the system bus 2603. Interfaces can use an application programming interface (API) 2612, a service layer 2613, or a combination of the API 2612 and service layer 2613. The API 2612 can include specifications for routines, data structures, and object classes. The API 2612 can be either computer-language independent or dependent. The API 2612 can refer to a complete interface, a single function, or a set of APIs.

The service layer 2613 can provide software services to the computer 2602 and other components (whether illustrated or not) that are communicably coupled to the computer 2602. The functionality of the computer 2602 can be accessible for all service consumers using this service layer. Software services, such as those provided by the service layer 2613, can provide reusable, defined functionalities through a defined interface. For example, the interface can be software written in JAVA, C++, or a language providing data in extensible markup language (XML) format. While illustrated as an integrated component of the computer 2602, in alternative implementations, the API 2612 or the service layer 2613 can be stand-alone components in relation to other components of the computer 2602 and other components communicably coupled to the computer 2602. Moreover, any or all parts of the API 2612 or the service layer 2613 can be implemented as child or sub-modules of another software module, enterprise application, or hardware module without departing from the scope of the present disclosure.

The computer 2602 includes an interface 2604. Although illustrated as a single interface 2604 in FIG. 26, two or more interfaces 2604 can be used according to particular needs, desires, or particular implementations of the computer 2602 and the described functionality. The interface 2604 can be used by the computer 2602 for communicating with other systems that are connected to the network 2630 (whether illustrated or not) in a distributed environment. Generally, the interface 2604 can include, or be implemented using, logic encoded in software or hardware (or a combination of software and hardware) operable to communicate with the network 2630. More specifically, the interface 2604 can include software supporting one or more communication protocols associated with communications. As such, the network 2630 or the interface's hardware can be operable to communicate physical signals within and outside of the illustrated computer 2602.

The computer 2602 includes a processor 2605. Although illustrated as a single processor 2605 in FIG. 26, two or more processors 2605 can be used according to particular needs, desires, or particular implementations of the computer 2602 and the described functionality. Generally, the processor 2605 can execute instructions and can manipulate data to perform the operations of the computer 2602, including operations using algorithms, methods, functions, processes, flows, and procedures as described in the present disclosure.

The computer 2602 also includes a database 2606 that can hold data for the computer 2602 and other components connected to the network 2630 (whether illustrated or not). For example, database 2606 can be an in-memory, conventional, or a database storing data consistent with the present disclosure. In some implementations, database 2606 can be a combination of two or more different database types (for example, hybrid in-memory and conventional databases) according to particular needs, desires, or particular implementations of the computer 2602 and the described functionality. Although illustrated as a single database 2606 in FIG. 26, two or more databases (of the same, different, or combination of types) can be used according to particular needs, desires, or particular implementations of the computer 2602 and the described functionality. While database 2606 is illustrated as an internal component of the computer 2602, in alternative implementations, database 2606 can be external to the computer 2602.

The computer 2602 also includes a memory 2607 that can hold data for the computer 2602 or a combination of components connected to the network 2630 (whether illustrated or not). Memory 2607 can store any data consistent with the present disclosure. In some implementations, memory 2607 can be a combination of two or more different types of memory (for example, a combination of semiconductor and magnetic storage) according to particular needs, desires, or particular implementations of the computer 2602 and the described functionality. Although illustrated as a single memory 2607 in FIG. 26, two or more memories 2607 (of the same, different, or combination of types) can be used according to particular needs, desires, or particular implementations of the computer 2602 and the described functionality. While memory 2607 is illustrated as an internal component of the computer 2602, in alternative implementations, memory 2607 can be external to the computer 2602.

The application 2608 can be an algorithmic software engine providing functionality according to particular needs, desires, or particular implementations of the computer 2602 and the described functionality. For example, application 2608 can serve as one or more components, modules, or applications. Further, although illustrated as a single application 2608, the application 2608 can be implemented as multiple applications 2608 on the computer 2602. In addition, although illustrated as internal to the computer 2602, in alternative implementations, the application 2608 can be external to the computer 2602.

The computer 2602 can also include a power supply 2614. The power supply 2614 can include a rechargeable or non-rechargeable battery that can be configured to be either user- or non-user-replaceable. In some implementations, the power supply 2614 can include power-conversion and management circuits, including recharging, standby, and power management functionalities. In some implementations, the power-supply 2614 can include a power plug to allow the computer 2602 to be plugged into a wall socket or a power source to, for example, power the computer 2602 or recharge a rechargeable battery.

There can be any number of computers 2602 associated with, or external to, a computer system containing computer 2602, with each computer 2602 communicating over network 2630. Further, the terms “client,” “user,” and other appropriate terminology can be used interchangeably, as appropriate, without departing from the scope of the present disclosure. Moreover, the present disclosure contemplates that many users can use one computer 2602 and one user can use multiple computers 2602.

Described implementations of the subject matter can include one or more features, alone or in combination.

For example, in a first implementation, a computer-implemented method for manufacturing a binder for spraying onto tools includes the following. A binder is manufactured for binding compacts onto a tool substrate. The binder is designed to provide a coating strength on the tool substrate. The binder includes: a metal selected from iron (Fe), cobalt (Co), and nickel (Ni); an alloy including the metal selected from Fe, Co, and Ni; or a refractory alloy selected from tungsten, tantalum (Ta), molybdenum (Mo), and niobium (Nb). An ultra-high-pressure, high-temperature operation is performed on pure wurtzite boron nitride (w-BN) powder to synthesize w-BN and cubic boron nitride (c-BN) compact. A binder-compact mixture is produced by turbulently mixing the binder with the compact in a mixer within a vacuum. The binder-compact mixture is thermally sprayed onto a tool substrate to coat the tool.

The foregoing and other described implementations can each, optionally, include one or more of the following features:

A first feature, combinable with any of the following features, where the binder includes an active brazing alloy (ABA) used for coating ultra-strong polycrystalline diamond compact (PDC) cutters, where active metal brazing using the ABA bonds superhard PDC cutting materials directly to tungsten carbide cobalt (WC/Co) substrate composites without metallization, and where the active metal brazing eliminates steps in a joining process and creates a strong, hermetic seal resistant to greater operating temperatures.

A second feature, combinable with any of the previous or following features, where the compact has a first size greater than particles of the pure w-BN powder, and where the ultra-high-pressure, high-temperature operation includes: pressurizing the pure w-BN powder to a pressure of approximately 20 gigapascals; heating the pure w-BN powder at a heating rate of 100° C./minute; and cooling the pure w-BN powder at a cooling rate of 50° C./minute.

A third feature, combinable with any of the previous or following features, the computer-implemented method further including cutting the compact to a second size smaller than the first size using laser cutting tools.

A fourth feature, combinable with any of the previous or following features, the computer-implemented method further including: identifying pieces of the compact having a size greater than a threshold size of a size range; and recutting, using the laser cutting tools, the pieces of the compact having the size greater than the threshold size.

A fifth feature, combinable with any of the previous or following features, the computer-implemented method further including cooling the compact with a cooling liquid during a cutting process that includes the cutting.

A sixth feature, combinable with any of the previous or following features, where the compact has an octahedron shape after being cut.

In a second implementation, a non-transitory, computer-readable medium storing one or more instructions executable by a computer system to perform operations including the following. A binder is manufactured for binding compacts onto a tool substrate. The binder is designed to provide a coating strength on the tool substrate. The binder includes: a metal selected from iron (Fe), cobalt (Co), and nickel (Ni); an alloy including the metal selected from Fe, Co, and Ni; or a refractory alloy selected from tungsten, tantalum (Ta), molybdenum (Mo), and niobium (Nb). An ultra-high-pressure, high-temperature operation is performed on pure wurtzite boron nitride (w-BN) powder to synthesize w-BN and cubic boron nitride (c-BN) compact. A binder-compact mixture is produced by turbulently mixing the binder with the compact in a mixer within a vacuum. The binder-compact mixture is thermally sprayed onto a tool substrate to coat the tool.

The foregoing and other described implementations can each, optionally, include one or more of the following features:

A first feature, combinable with any of the following features, where the binder includes an active brazing alloy (ABA) used for coating ultra-strong polycrystalline diamond compact (PDC) cutters, where active metal brazing using the ABA bonds superhard PDC cutting materials directly to tungsten carbide cobalt (WC/Co) substrate composites without metallization, and where the active metal brazing eliminates steps in a joining process and creates a strong, hermetic seal resistant to greater operating temperatures.

A second feature, combinable with any of the previous or following features, where the compact has a first size greater than particles of the pure w-BN powder, and where the ultra-high-pressure, high-temperature operation includes: pressurizing the pure w-BN powder to a pressure of approximately 20 gigapascals; heating the pure w-BN powder at a heating rate of 100 ° C./minute; and cooling the pure w-BN powder at a cooling rate of 50° C./minute.

A third feature, combinable with any of the previous or following features, the operations further including cutting the compact to a second size smaller than the first size using laser cutting tools.

A fourth feature, combinable with any of the previous or following features, the operations further including: identifying pieces of the compact having a size greater than a threshold size of a size range; and recutting, using the laser cutting tools, the pieces of the compact having the size greater than the threshold size.

A fifth feature, combinable with any of the previous or following features, the operations further including cooling the compact with a cooling liquid during a cutting process that includes the cutting.

A sixth feature, combinable with any of the previous or following features, where the compact has an octahedron shape after being cut.

In a third implementation, a computer-implemented system, including one or more processors and a non-transitory computer-readable storage medium coupled to the one or more processors and storing programming instructions for execution by the one or more processors, the programming instructions instructing the one or more processors to perform operations including the following. A binder is manufactured for binding compacts onto a tool substrate. The binder is designed to provide a coating strength on the tool substrate. The binder includes: a metal selected from iron (Fe), cobalt (Co), and nickel (Ni); an alloy including the metal selected from Fe, Co, and Ni; or a refractory alloy selected from tungsten, tantalum (Ta), molybdenum (Mo), and niobium (Nb). An ultra-high-pressure, high-temperature operation is performed on pure wurtzite boron nitride (w-BN) powder to synthesize w-BN and cubic boron nitride (c-BN) compact. A binder-compact mixture is produced by turbulently mixing the binder with the compact in a mixer within a vacuum. The binder-compact mixture is thermally sprayed onto a tool substrate to coat the tool.

The foregoing and other described implementations can each, optionally, include one or more of the following features:

A first feature, combinable with any of the following features, where the binder includes an active brazing alloy (ABA) used for coating ultra-strong polycrystalline diamond compact (PDC) cutters, where active metal brazing using the ABA bonds superhard PDC cutting materials directly to tungsten carbide cobalt (WC/Co) substrate composites without metallization, and where the active metal brazing eliminates steps in a joining process and creates a strong, hermetic seal resistant to greater operating temperatures.

A second feature, combinable with any of the previous or following features, where the compact has a first size greater than particles of the pure w-BN powder, and where the ultra-high-pressure, high-temperature operation includes: pressurizing the pure w-BN powder to a pressure of approximately 20 gigapascals; heating the pure w-BN powder at a heating rate of 100 ° C./minute; and cooling the pure w-BN powder at a cooling rate of 50° C./minute.

A third feature, combinable with any of the previous or following features, the operations further including cutting the compact to a second size smaller than the first size using laser cutting tools.

A fourth feature, combinable with any of the previous or following features, the operations further including: identifying pieces of the compact having a size greater than a threshold size of a size range; and recutting, using the laser cutting tools, the pieces of the compact having the size greater than the threshold size.

A fifth feature, combinable with any of the previous or following features, the operations further including cooling the compact with a cooling liquid during a cutting process that includes the cutting.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random- or serial-access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, or implemented as, special-purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/-R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touchscreen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method to form a tool for oil and gas application, the method comprising:
manufacturing a binder for binding compacts onto a tool substrate and providing a coating strength on the tool substrate, the binder comprising:
a metal selected from iron (Fe), cobalt (Co), and nickel (Ni);
an alloy including the metal selected from Fe, Co, and Ni; or
a refractory alloy selected from tungsten (W), tantalum (Ta), molybdenum (Mo), and niobium (Nb);
performing an ultra-high-pressure, high-temperature operation on pure wurtzite boron nitride (w-BN) powder to synthesize w-BN and cubic boron nitride (c-BN) compact;
producing a binder-compact mixture by turbulently mixing the binder with the compact in a mixer within a vacuum; and
thermally spraying the binder-compact mixture onto a tool substrate to coat the tool.

2. The computer-implemented method of claim 1, wherein the binder comprises an active brazing alloy (ABA) used for coating ultra-strong polycrystalline diamond compact (PDC) cutters, wherein active metal brazing using the ABA bonds superhard PDC cutting materials directly to tungsten carbide cobalt (WC/Co) substrate composites without metallization, and wherein the active metal brazing eliminates steps in a joining process and creates a strong, hermetic seal resistant to greater operating temperatures.

3. The computer-implemented method of claim 1, wherein the compact has a first size greater than particles of the pure w-BN powder, and wherein the ultra-high-pressure, high-temperature operation comprises:
pressurizing the pure w-BN powder to a pressure of approximately 20 gigapascals;
heating the pure w-BN powder at a heating rate of 100° C./minute; and
cooling the pure w-BN powder at a cooling rate of 50° C./minute.

4. The computer-implemented method of claim 3, further comprising cutting the compact to a second size smaller than the first size using laser cutting tools.

5. The computer-implemented method of claim 4, further comprising:
identifying pieces of the compact having a size greater than a threshold size of a size range; and
recutting, using the laser cutting tools, the pieces of the compact having the size greater than the threshold size.

6. The computer-implemented method of claim 5, further comprising cooling the compact with a cooling liquid during a cutting process that includes the cutting.

7. The computer-implemented method of claim 4, wherein the compact has an octahedron shape after being cut.

8. A non-transitory, computer-readable medium storing one or more instructions executable by a computer system to perform operations comprising:
manufacturing a binder for binding compacts onto a tool substrate and providing a coating strength on the tool substrate, the binder comprising:
a metal selected from iron (Fe), cobalt (Co), and nickel (Ni);
an alloy including the metal selected from Fe, Co, and Ni; or
a refractory alloy selected from tungsten (W), tantalum (Ta), molybdenum (Mo), and niobium (Nb);
performing an ultra-high-pressure, high-temperature operation on pure wurtzite boron nitride (w-BN) powder to synthesize w-BN and cubic boron nitride (c-BN) compact;
producing a binder-compact mixture by turbulently mixing the binder with the compact in a mixer within a vacuum; and
thermally spraying the binder-compact mixture onto a tool substrate to coat the tool.

9. The non-transitory, computer-readable medium of claim 8, wherein the binder comprises an active brazing alloy (ABA) used for coating ultra-strong polycrystalline diamond compact (PDC) cutters, wherein active metal brazing using the ABA bonds superhard PDC cutting materials directly to tungsten carbide cobalt (WC/Co) substrate composites without metallization, and wherein the active metal brazing eliminates steps in a joining process and creates a strong, hermetic seal resistant to greater operating temperatures.

10. The non-transitory, computer-readable medium of claim 8, wherein the compact has a first size greater than particles of the pure w-BN powder, and wherein the ultra-high-pressure, high-temperature operation comprises:
pressurizing the pure w-BN powder to a pressure of approximately 20 gigapascals;
heating the pure w-BN powder at a heating rate of 100° C./minute; and
cooling the pure w-BN powder at a cooling rate of 50° C./minute.

11. The non-transitory, computer-readable medium of claim 10, further comprising cutting the compact to a second size smaller than the first size using laser cutting tools.

12. The non-transitory, computer-readable medium of claim 11, further comprising:
identifying pieces of the compact having a size greater than a threshold size of a size range; and
recutting, using the laser cutting tools, the pieces of the compact having the size greater than the threshold size.

13. The non-transitory, computer-readable medium of claim 12, further comprising cooling the compact with a cooling liquid during a cutting process that includes the cutting.

14. The non-transitory, computer-readable medium of claim 11, wherein the compact has an octahedron shape after being cut.

15. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
manufacturing a binder for binding compacts onto a tool substrate and providing a coating strength on the tool substrate, the binder comprising:
a metal selected from iron (Fe), cobalt (Co), and nickel (Ni);
an alloy including the metal selected from Fe, Co, and Ni; or
a refractory alloy selected from tungsten (W), tantalum (Ta), molybdenum (Mo), and niobium (Nb);
performing an ultra-high-pressure, high-temperature operation on pure wurtzite boron nitride (w-BN) powder to synthesize w-BN and cubic boron nitride (c-BN) compact;
producing a binder-compact mixture by turbulently mixing the binder with the compact in a mixer within a vacuum;
and thermally spraying the binder-compact mixture onto a tool substrate to coat the tool.

16. The computer-implemented system of claim 15, wherein the binder comprises an active brazing alloy (ABA) used for coating ultra-strong polycrystalline diamond compact (PDC) cutters, wherein active metal brazing using the ABA bonds superhard PDC cutting materials directly to tungsten carbide cobalt (WC/Co) substrate composites without metallization, and wherein the active metal brazing eliminates steps in a joining process and creates a strong, hermetic seal resistant to greater operating temperatures.

17. The computer-implemented system of claim 15, wherein the compact has a first size greater than particles of the pure w-BN powder, and wherein the ultra-high-pressure, high-temperature operation comprises:
pressurizing the pure w-BN powder to a pressure of approximately 20 gigapascals;
heating the pure w-BN powder at a heating rate of 100° C./minute; and
cooling the pure w-BN powder at a cooling rate of 50° C./minute.

18. The computer-implemented system of claim 17, further comprising cutting the compact to a second size smaller than the first size using laser cutting tools.

19. The computer-implemented system of claim 18, further comprising:
identifying pieces of the compact having a size greater than a threshold size of a size range; and
recutting, using the laser cutting tools, the pieces of the compact having the size greater than the threshold size.

20. The computer-implemented system of claim 19, further comprising cooling the compact with a cooling liquid during a cutting process that includes the cutting.
